(19) United States
(12) Patent Application Publication
(10) Pub. No.: US 2025/0182188 A1
(43) Pub. Date: Jun. 5, 2025

(54) MESSAGE PROCESSING APPARATUS, MESSAGE PROCESSING METHOD, AND MESSAGE PROCESSING PROGRAM

(71) Applicant: NEC Platforms, Ltd., Kawasaki-shi (JP)

(72) Inventors: Hiroshi SAKAMOTO, Kanaawa (JP); Naomi KAKINAGA, Kanagawa (JP); Masaru Kubota, Kanagawa (JP); Hikaru UDAGAWA, Kanagawa (JP)

(73) Assignee: NEC Platforms, Ltd., Kawasaki-shi (JP)

(21) Appl. No.: 18/929,958

(22) Filed: Oct. 29, 2024

(30) Foreign Application Priority Data
Dec. 4, 2023 (JP) 2023-204848

(51) Int. Cl. G06Q 30/0601; G06Q 20/18; G06Q 50/12; H04L 67/02

(52) U.S. Cl. CPC G06Q 30/0641; G06Q 20/18; G06Q 50/12; H04L 67/02

(57) ABSTRACT

A message processing apparatus, comprising: a terminal device interface part configured to be connected to a plurality of terminal devices with a first API provided by each of the plurality of terminal devices; an order processing apparatus interface part configured to be connected to a self-ordering system with a second API different from the first API via a mobile order interface; an event workflow database configured to have correspond each of a plurality of events and each of a plurality of workflows to each other to store the events and the workflows; and a message generation part configured to receive an event message(s) of the first API and generate a message(s) corresponding to the second API.

### FIELD

### Cross Reference to Related Applications

The present invention is based on the priority claim of Japanese Patent Application No. 2023-204848 (filed on Dec. 4, 2023), the entire contents of which are incorporated herein by reference.

The present disclosure relates to a message processing apparatus, a message processing method, and a message processing program.

### BACKGROUND

For example, a system is known that allows a customer to operate a dedicated terminal without help of an employee to make an order for dish(es), notify the order to a kitchen, and pay for the dish(es) in a restaurant in response to this operation. For instance, Patent Document (PTL) 1 discloses an example of such a system. Note that, such a system may be called as a self-ordering system.
[PTL 1] Japanese Patent Kokai Publication No. 2019-197543 A

### SUMMARY

The disclosures of the above prior art document are incorporated herein by reference. The following analysis is provided by the present inventors.

Here, in order to allow users to receive service(s) such as reservations offered by various companies, it may become necessary newly to add and connect a terminal device(s) to an existing system that transmits and receives messages in a format different from format(s) of existing terminal device(s). In such cases, it is desirable to connect a new terminal device(s) to an existing system at any time without stopping the system.

It is an object of the present disclosure to provide a message processing apparatus, a message processing method, and a message processing program that contribute to allowing a new terminal device(s) that transmits and receives messages in a format(s) different from format(s) of existing terminal device(s) to be added and is connected to an existing system at any time without stopping the system.

According to a first aspect of the present disclosure, there is provided a message processing apparatus, comprising:
a terminal device interface part configured to be connected to a plurality of terminal devices with a first API provided by each of the plurality of terminal devices;
an order processing apparatus interface part configured to be connected to a self-ordering system with a second API different from the first API via a mobile order interface;
an event workflow database configured to have correspond each of a plurality of events and each of a plurality of workflows to each other to store the events and the workflows; and
a message generation part configured to receive an event message(s) of the first API and generate a message(s) corresponding to the second API.

According to a second aspect of the present disclosure, there is provided a self-ordering system comprising a message processing apparatus according to the first aspect, and an order processing apparatus is provided.

The order processing apparatus is configured to receive a message(s) of the event corresponding to the generated second API and to perform a process of the event.

According to a third aspect of the present disclosure, there is provided a message processing method comprising: a reception step, a message conversion step, a workflow selection step, a message abstraction step, a message generation step, and a message generation step.

The reception step receives a message(s) of each of a plurality of events from each of a plurality of terminal devices with a first API that differs for each of the plurality of terminal devices.

The message conversion step converts the received message(s) for each of the plurality of events into a general-purpose format independent of the plurality of terminal devices.

The workflow selection step selects from the event workflow database one of the plurality of workflows corresponding to the message(s) of one of the plurality of events converted into the general-purpose format. The message abstraction step abstracts the message(s) of the event corresponding to the selected workflow by converting the message(s) into a format that includes all of the messages of the plurality of events. The message generation step executes the selected workflow with the abstracted message(s) of the event to generate a message(s) corresponding to a second API.

The message output step outputs the generated message(s) corresponding to the second API.

According to a fourth aspect of the present disclosure, there is provided a program, comprising a storage process, a reception process, a message conversion process, a workflow selection process, a message abstraction process, a message generation process and a message output process.

The storage process has correspond each of a plurality of events and each of a plurality of workflows to each other to store the events, the workflows in an event workflow database.

The reception process receives a message(s) of each of a plurality of events from each of a plurality of terminal devices with a first API that differs for each of the plurality of terminal devices.

The message conversion process converts the received message(s) for each of the plurality of events into a general-purpose format independent of the plurality of terminal devices;

The workflow selection process selects from the event workflow database one of the plurality of workflows corresponding to the message(s) of one of the plurality of events converted into the general-purpose format.

The message abstraction process abstracts the message(s) of the event corresponding to the selected workflow by converting the message(s) into a format that includes all of the messages of the plurality of events. The message generation process executes the selected workflow with the abstracted message(s) of the event to generate a message(s) corresponding to a second API.

The message output process outputs message(s) corresponding to the second API.

Note that, the program may be stored in a computer readable storage medium. The storage medium may be a non-transitory storage medium such as a semiconductor memory, a hard disk, a magnetic recording medium, or an optical recording medium. In other words, the present disclosure may be embodied as a computer program product(s).

According to each of the aspects of the present disclosure, it is made possible to contribute to allowing a new terminal device(s) that transmits and receives message(s) in a format different from format(s) of existing terminal device(s) to be added and connected to an existing system at any time without stopping the system.

### BRIEF DESCRIPTION OF DRAWINGS

FIG. 1 is a diagram exemplifying an example configuration of a self-ordering system.

FIG. 2 is a diagram exemplifying an example configuration of the self-ordering system according to the present disclosure.

FIG. 3A is a diagram exemplifying an example configuration of a message processing apparatus shown in FIG. 2.

FIG. 3B is a diagram exemplifying an example configuration of a terminal device IF part shown in FIG. 3A.

FIG. 3C is a diagram exemplifying an example configuration of a message generation part shown in FIG. 3A.

FIG. 3D is a diagram exemplifying example information stored in an event workflow database (event workflow DB) shown in FIG. 3A.

FIG. 4A is a diagram exemplifying an example message (payment message) used when a user using a mobile terminal device A of company A makes a payment, the payment message converted into a general-purpose format, and an abstracted payment message.

FIG. 4B is a diagram exemplifying an example payment message used when a user using a mobile terminal device B for Company B makes a payment, a payment message converted into a general-purpose format, and an abstracted payment message.

FIG. 5A is a diagram exemplifying an example message (refund message) used when a user of a mobile terminal device A of company A receives a refund of payment, the refund message converted into a general-purpose format, and an abstracted refund message.

FIG. 5B is a diagram exemplifying an example refund message used when a user of a mobile terminal device B of company B receives a refund of payment, the refund message converted into a general-purpose format, and an abstracted refund message.

FIG. 6 is a sequence diagram exemplifying an example operation of the self-ordering system shown in FIG. 2, etc.

FIG. 7 is a flow chart exemplifying an example process of S16 shown in FIG. 6.

FIG. 8 is a diagram exemplifying an example configuration of the information processing apparatus executing a program realizing the processing of the components of the self-ordering systems.

### EXAMPLE EMBODIMENTS

Hereinafter, an example embodiment of the present disclosure will be described with reference to drawings. However, the present disclosure is not limited to the example embodiment described below. In addition, in each of the drawings, the same or corresponding elements are appropriately assigned the same reference numerals. Further, it should be noted that the drawings are schematic, and the dimensional relationship of each element, the ratio of each element, and the like may differ from reality. There may also be parts in which the dimensional relationship and ratio of each element differ between the drawings.

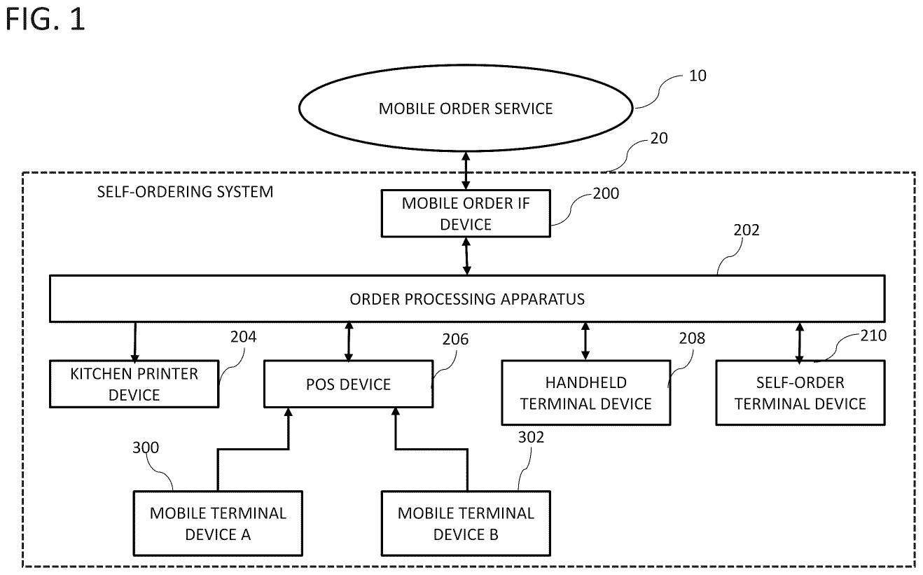

FIG. 1 is a diagram exemplifying an example configuration of a self-ordering system 20. As shown in FIG. 1, the self-ordering system 20 is connected to a mobile order service 10. Each of a plurality of companies may operate a mobile order service 10 for restaurant reservations, etc., and in such a case, the self-ordering system 20 may be connected to a plurality of mobile order services 10.

The mobile order service 10 and the self-ordering system 20 are connected via a wired communication line, a wireless communication line, or their combination, for example, via the Internet. Note that, in the following description, the self-ordering system 20 being use in a restaurant providing food(s)/drink(s) to customers will be a specific example. However, with appropriate modifications, the self-ordering system 20 can be used for various purposes not only in the restaurant, but also in various companies engaged in the service industries such as retail store(s), manufacturing, and agriculture, etc. In other words, the self-ordering system 20 can be used to provide various services to users of these companies.

First, an example of the components of the self-ordering system 20 will be described. The mobile order service 10 provides customers of a restaurant via the Internet with services such as restaurant introductions, reviews, reservations, and payments. Specifically exemplifying, the mobile order service 10 is operated by a company providing the above mentioned restaurant related services, such as “dinii (a trademark of dinii Inc.)” or “Gurunavi (registered trademark)”. However, the companies exemplified here are merely examples, and the mobile order service 10 may be operated by a company other than these.

The self-ordering system 20 comprises a mobile order interface (mobile order IF; InterFace) device 200 connecting the mobile order service 10 and the order processing apparatus 202, an order processing apparatus 202, a kitchen printer device 204, a POS (Point of Sales) device 206, a handheld terminal device 208, a self-order terminal device 210, a mobile terminal device A 300, and a mobile terminal device B 302. These component elements are connected to each other via wired communication lines installed throughout the restaurant or via wireless communication lines such as Wi-Fi (registered trademark). Note that, in FIG. 1, an example in which the self-ordering system 20 comprises two types of mobile terminal devices is exemplified, the mobile terminal device A 300 and the mobile terminal device B 302. However, the self-ordering system 20 may appropriately comprise three or more types of mobile terminal devices used to receive services from three or more companies.

The self-ordering system 20, with these components, receives at least one of information and message(s) related to an event, such as an order for dish(es) provided by the restaurant, from a customer(s) who visits the restaurant. Note that, hereinafter, for the sake of brevity, “information and/or message(s)” will simply be referred to as “message(s)”. Further, the self-ordering system 20 manages message(s) related to the received events. By using the managed message(s), the self-ordering system 20 performs processing for the various events and executes these events. Note that, the events may include one or more of reservations at the restaurant, ordering dish(es), and paying for the ordered dish(es) (payment or settlement). Further, the events may include one or more within a refund(s) of the price(s) of the dish(es) (refund), presenting the detail(s) of the dish order(s) to a chef(s) in the kitchen, and managing the time required from ordering the dish(es) to providing the dish(es). However, these events are mere examples, and the events are not limited to these.

Restaurant employees are waiter(s) and waitress(es) who provide services (work(s)) such as serving dish(es) (product(s)) to the customers' tables, clearing away dish(es) after meal(s), and taking care of the customers' clothes/luggage. However, when a restaurant is a self-service restaurant, the restaurant does not do anything for the customer(s) other than providing dish(es). Also, all the restaurants may not necessarily provide the above mentioned services to the customer(s) in addition to providing food(s)/drink(s).

The mobile order IF device 200 connects the mobile order service 10 and the order processing apparatus 202 of the self-ordering system 20 via Web API and HTTP/HTTPS protocols, enabling the transmission and reception of information between them. The order processing apparatus 202 receives and manages order information, payment information, refund information, reservation information, etc., and executes processing for these events by using the managed information to perform various operations, using message(s) of each of the events. The order information, the payment information, the refund information, etc. are input by the customer(s) and the employee(s) to the POS device 206, the handheld terminal device 208, the self-order terminal device 210, the mobile terminal device A 300, the mobile terminal device B 302, and the POS device 206. The reservation information indicating reservations at the restaurant, etc. are received by the order processing apparatus 202 from the mobile order service 10, or are input by the employee(s) to the order processing apparatus 202 based on the contents of a phone calls from the customers.

The mobile terminal device A 300 is connected to the POS device 206 via a wireless communication line such as Wi-Fi or a wired communication line with an API provided by the mobile terminal device A 300. The mobile terminal device B 302 is connected to the POS device 206 with an API provided by the mobile terminal device B 302 via a wireless communication line such as Wi-Fi.

For example, the mobile terminal device A 300 and the mobile terminal device B 302 are mobile payment terminals provided by a mobile payment service provider, specifically exemplifying, are operated by companies providing payments, such as “SB C&S (a trademark of SoftBank Group Corp.)” or “Fiserv (registered trademark)”. While a configuration is exemplified in FIG. 1 including mobile terminal device A 300 and mobile terminal device B302, a typical restaurant will connect mobile payment terminals of a single payment service provider with which the restaurant has a contract.

The order processing apparatus 202 receives and manages the order information indicating the detail(s) of dish(es) orders by the customer(s), and performs processing to print out the order information from the kitchen printer device 204 mainly located in the kitchen. By this processing, an event is executed for instructing the chef(s) in the kitchen on the detail(s) of the order(s) from the customer(s). The order processing apparatus 202 may execute processing to print out the payment information and a barcode indicating the payment information, etc., together with the order information on a receipt(s) from the kitchen printer device 204. When the customer(s) uses the barcode reading function of the POS device 206, the mobile terminal device A 300, and the mobile terminal device B302 to read the payment(s) information and barcode(s) printed out on the receipt(s), an event(s) to pay for the dish(es) is executed.

The handheld terminal device 208 is connected to the order processing apparatus 202 via a wireless communication line such as Wi-Fi. The handheld terminal device 208 is used by employee(s). The employee(s) listen to the dish order(s) from the customer(s) and operates the handheld terminal device 208 to input the order information. The handheld terminal device 208 receives the order information in response to the employee(s)'s operation and outputs the order information to the order processing apparatus 202. The order processing apparatus 202 receives and manages the order information from the handheld terminal device 208 to perform processing such as printing out the order information from the kitchen printer device 204 located in the kitchen, as described above.

The self-order terminal device 210 is connected to the order processing apparatus 202 via a wireless communication line such as Wi-Fi. The self-order terminal device 210 is used by the customer(s) who is seated at a table(s) in the restaurant. The customer(s) operates the self-order terminal device 210 to input the order information or the payment information. The self-order terminal device 210 receives the order information or the payment information in response to the customer(s)'s operation to output the received information to the order processing apparatus 202. The order processing apparatus 202 receives and manages the order information or the payment information from the self-order terminal device 210 to perform processing such as printing out the information from the kitchen printer device 204 located in the kitchen, as described above.

### Example Embodiment

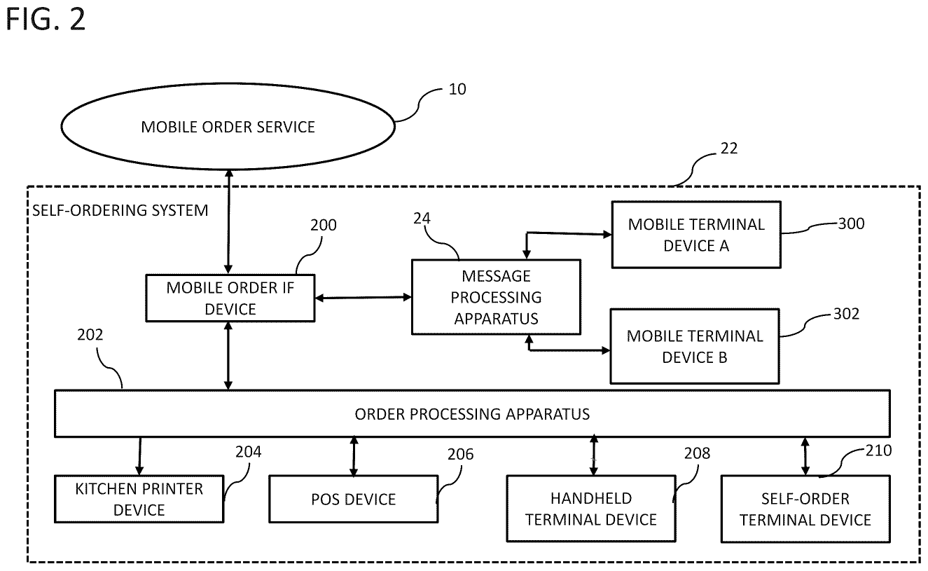

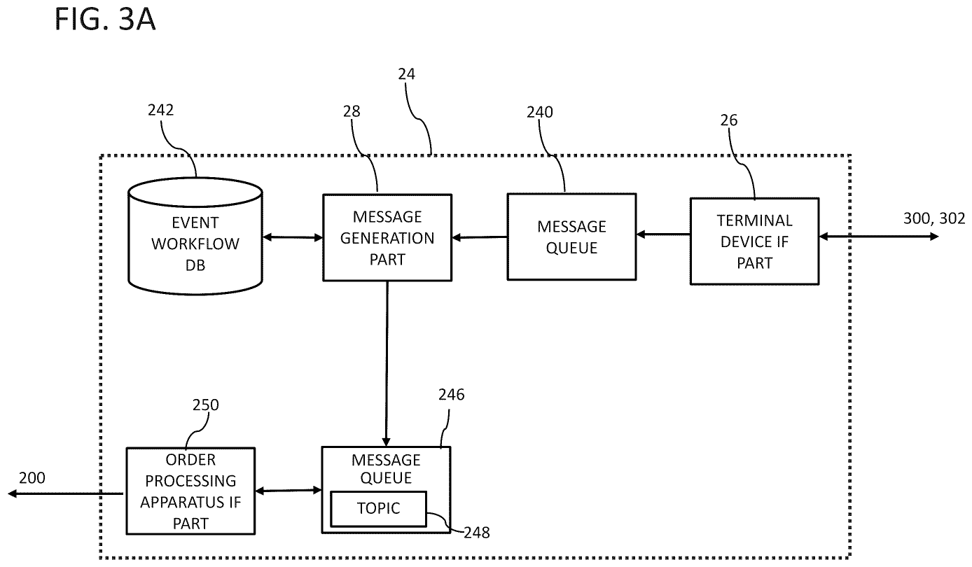

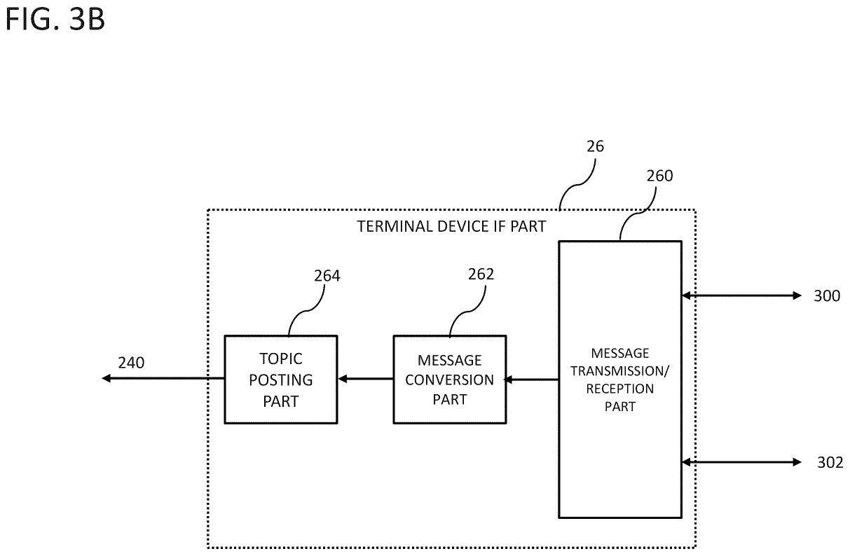

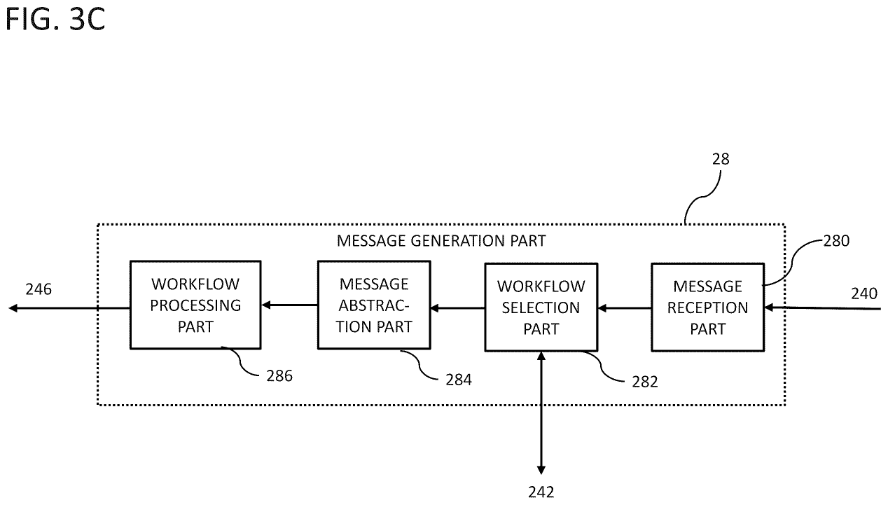

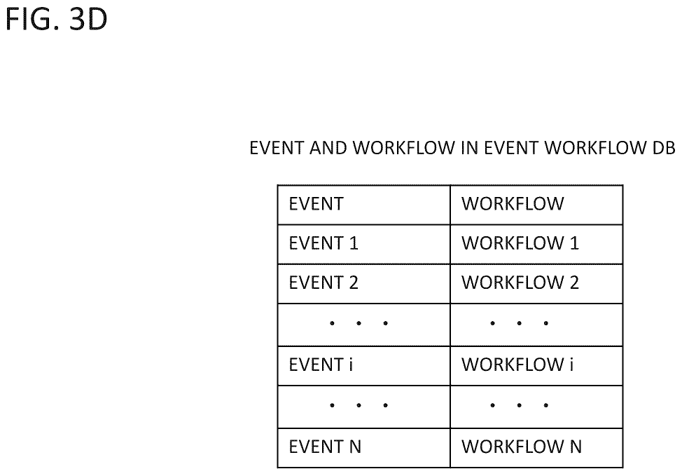

FIG. 2 is a diagram exemplifying an example configuration of a self-ordering system 22 according to the present disclosure. FIG. 3A is a diagram exemplifying an example configuration of a message processing apparatus 24 shown in FIG. 2. FIG. 3B is a diagram exemplifying an example configuration of a terminal device IF part 26 shown in FIG. 3A. FIG. 3C is a diagram exemplifying an example configuration of a message generation part 28 shown in FIG. 3A. FIG. 3D is a diagram exemplifying example information stored in an event workflow database (event workflow DB) 242 shown in FIG. 3A.

Hereinafter, as an example embodiment according to the present disclosure, an example of a self-ordering system 22 in which the configuration of the self-ordering system 20 described above is modified will be described. In the following description, it is assumed a case where a mobile terminal device A 300 and a mobile terminal device B 302 are newly introduced to the self-ordering system 20. In this case, the mobile terminal device A 300 and the mobile terminal device B 302 provide APIs to the POS device 206, and the POS device 206, the mobile terminal device A 300, and the mobile terminal device B 302 need to transmit and receive message(s) using these APIs. Therefore, in order to enable the POS device 206 to communicate with the mobile terminal device B 302 using the new APIs, it becomes necessary to modify a program(s) executed in the POS device 206. In order to modify the program(s) of the POS device 206 in this way, it is necessary to stop processing of the self-ordering system 20. Therefore, in order to newly introduce the mobile terminal device A 300 and the mobile terminal device B 302 into the self-ordering system 20, the restaurant is affected in such a way as interruption of the restaurant's business.

In addition, there are many companies that operate mobile payment terminals to provide a variety of services related to restaurants. On the other hand, because a variety of customers visit restaurants, the customers have diverse needs for services. Therefore, it is difficult for a restaurant to restrictively select services offered by the various companies that operate mobile payment terminals to be used in the self-ordering system 20. In addition, number of companies that operate mobile payment terminals to provide services to restaurant customers is increasing very rapidly. In other words, self-ordering system 20 must quickly support the services provided by the many companies operating mobile payment terminals. The self-ordering system 22 shown in FIG. 2 has a configuration meeting these demands.

As shown in FIG. 2, the self-ordering system 22 differs in configuration from the self-ordering system 20. That is, in the self-ordering system 22, the mobile terminal device A 300 and the mobile terminal device B 302 are connected to the order processing apparatus 202 via the message processing apparatus 24 and the mobile order IF device 200, not via the POS device 206. Like the self-ordering system 20, the self-ordering system 22 manages message(s) related to events accepted from the message processing apparatus 24. The managed message(s) are used to perform processing for various events to execute these events. Note that, like the self-ordering system 20, the self-ordering system 22 may be used not only for the provision of dish(es) and service(s) in a restaurant, but also for the provision of various products and services by various companies either of these.

The message processing apparatus 24 and the mobile terminal device A 300 are connected via a wireless communication line such as Wi-Fi using an API provided by the mobile terminal device A 300. The message processing apparatus 24 and the mobile terminal device B 302 are connected via a wireless communication line such as Wi-Fi using an API provided by the mobile terminal device B 302. The message processing apparatus 24 transmits and receives message(s) between the mobile terminal device A 300 and the mobile terminal device B 302 to execute a workflow corresponding to the transmitted and received message(s) to output the generated message(s) to the order processing apparatus 202.

Note that, the message processing apparatus 24 may be the UNIVERGE (registered trademark) Integration Platform (UIP) that connects the order processing apparatus 202 to the mobile terminal device A 300 and the mobile terminal device B 302 using the Web API. When the UIP is used as the order processing apparatus 202, a workflow for realizing the events and the message(s) used for processing the event may be easily defined using a GUI.

As shown in FIG. 3A, the message processing apparatus 24 comprises a terminal device IF part 26 connected to the mobile terminal device A 300 and the mobile terminal device B 302, a message queue 240, a message generation part 28, an event workflow DB 242, a message queue 246, and an order processing apparatus IF part 250. Note that, the workflow(s) and its message(s) queued in the message queue 246 may be treated as a topic(s) 248.

As shown in FIG. 3B, the terminal device IF part 26 of the message processing apparatus 24 comprises a message transmission/reception part 260, a message conversion part 262, and a topic posting part 264. As shown in FIG. 3C, the message generation part 28 of the message processing apparatus 24 comprises a message reception part 280, a workflow selection part 282, a message abstraction part 284, and a workflow processing part 286.

As shown in FIG. 3D, the event workflow DB 242 of the message processing apparatus 24 have correspond each of N types of events “1” to “N” and each of the definitions of workflows “1” to “N” for the events “1” to “N” in the self-ordering system 20 (N≥1) to store the events and the workflows. Note that, the event workflow DB 242 stores the events “1” to “N” and the workflows “1” to “N” corresponding to them in advance before the processing of the mobile terminal device is started.

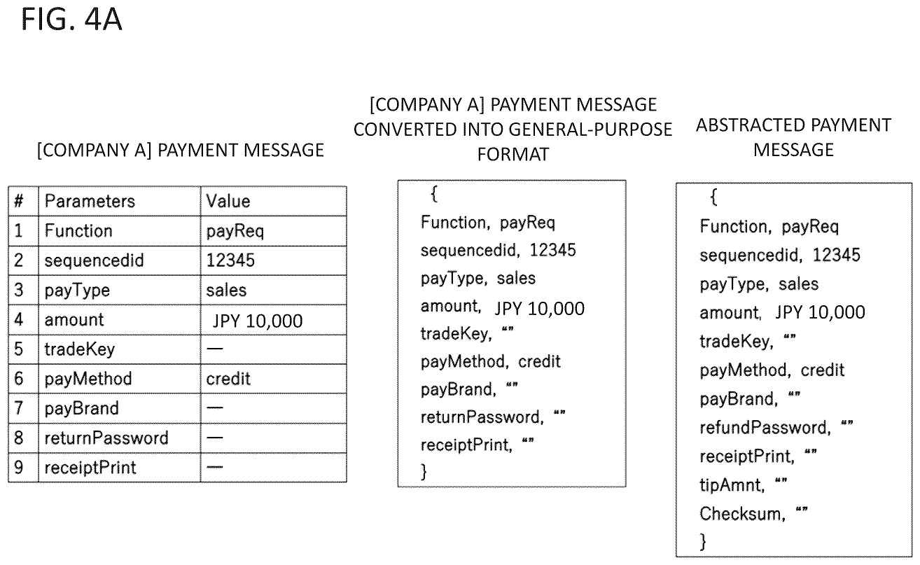

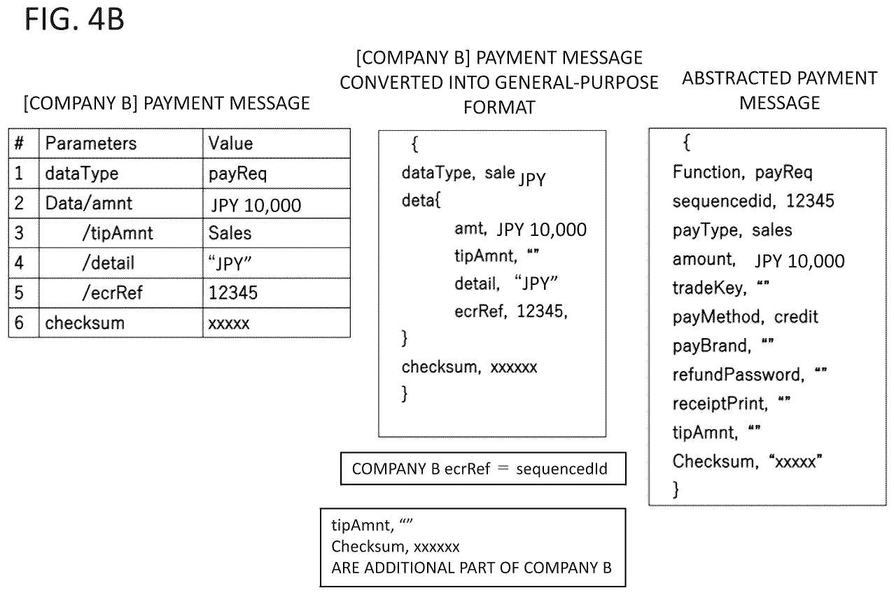

FIG. 4A is a diagram exemplifying example message (payment message) used when a user using a mobile terminal device A 300 of company A makes a payment, the payment message converted into a general-purpose format, and abstracted payment message. FIG. 4B is a diagram exemplifying example payment message used when a user using a mobile terminal device B 302 for company B makes a payment, a payment message converted into a general-purpose format, and abstracted payment message.

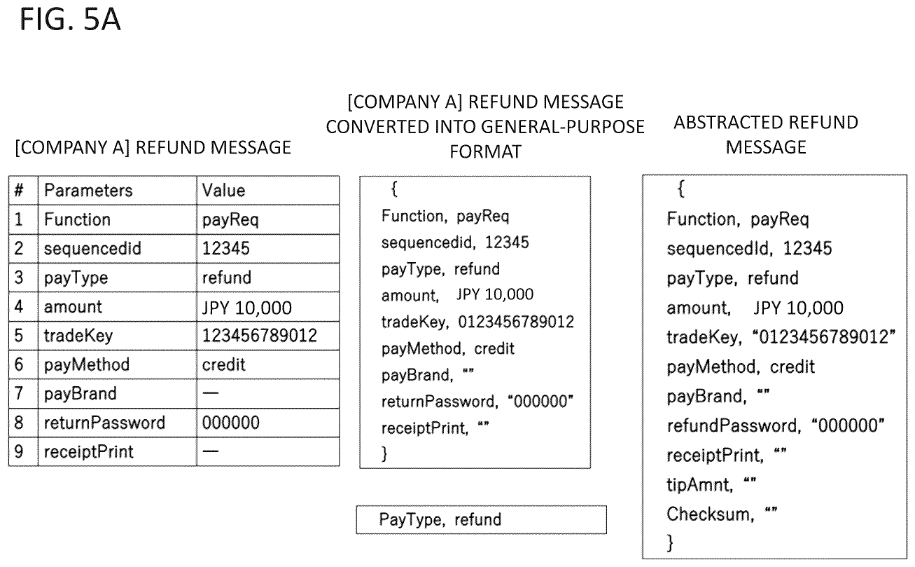

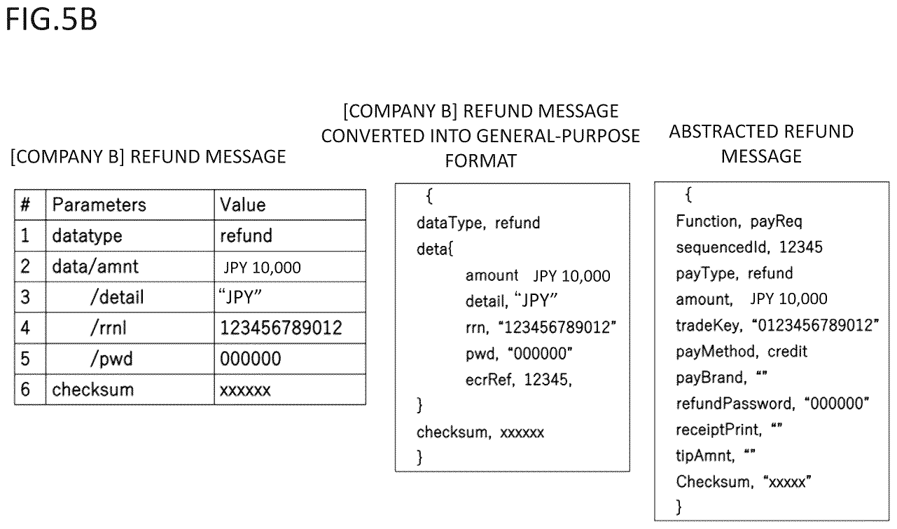

FIG. 5A is a diagram exemplifying example message (refund message) used when a user of a mobile terminal device A 300 of company A receives a refund of payment, the refund message converted into a general-purpose format, and an abstracted refund message. FIG. 5B is a diagram exemplifying example refund message used when a user of a mobile terminal device B 302 of company B receives a refund of payment, the refund message converted into a general-purpose format, and an abstracted refund message.

The conversion of message(s) into a general-purpose format is achieved by converting message(s) from the mobile terminal device A 300 and the mobile terminal device B 302 into a format that is common to these messages and does not depend on either of these messages, such as the Json format. Further, the abstraction of message(s) is achieved by converting message(s) from the mobile terminal device A 300 and the mobile terminal device B 302 in the general-purpose format into a format that can include both of these messages.

Note that the abstracted payment message shown in FIG. 4A is the same as the abstracted payment message shown in FIG. 4B. Also, the abstracted refund message shown in FIG. 5A are the same as the abstracted refund message shown in FIG. 5B. Note that, in FIG. 4A to FIG. 5B, “payReq” in “Function” indicates a payment request, “12345” in “sequenced” indicates the identification number of the processing sequence, and “JPY10,000” in “amount” indicates the amount to be paid. Also, in FIG. 4A to FIG. 5B, “sales” in “payType” indicates sales, “Credit” in “pay Method” indicates that the payment was made by credit card, and “xxxxxx” in “checksum” indicates a checksum used to detect errors in the message(s).

As shown in FIG. 3A and FIG. 3B, in the message processing apparatus 24, the message transmission/reception part 260 of the terminal device IF part 26 transmits and receives message(s) between the mobile terminal device A 300 and the mobile terminal device B 302. The message transmission/reception part 260 outputs message(s) received from the mobile terminal device A 300 and the mobile terminal device B 302 to the message conversion part 262. The payment event message received from the mobile terminal device A 300 has the format shown on the left side of FIG. 4A, for example. On the other hand, the payment event message received from mobile terminal device B 302 has the format shown on the left side of FIG. 4B, for example. On the other hand, the refund event message received from the mobile terminal device B 302 has the format shown on the left side of FIG. 5B, for example. In other words, the format of the event message that the message transmission/reception part 260 receives from the mobile terminal device A 300 depends on the service provided by company A. On the other hand, the format of the event message that the message transmission/reception part 260 receives from the mobile terminal device B 302 depends on the service provided by company B.

The message conversion part 262 converts the message(s) of an event (e.g., event “i”; N≥i≥1) input from the message transmission/reception part 260 and dependent on the services provided by companies A and B into a general-purpose format. The message conversion part 262 outputs the message(s) of the event “i” converted into the general-purpose format to the topic posting part 264. Note that, the payment event message received from the mobile terminal device A 300 is generalized to have the format shown in the center of FIG. 4A, for example. On the other hand, the payment event message received from the mobile terminal device B 302 is generalized to have the format shown in the center of FIG. 4B, for example. Also, the message of the refund event received from the mobile terminal device A 300 is generalized to have the format shown in the center of FIG. 5A, for example. On the other hand, the message of the refund event received from the mobile terminal device B 302 is generalized to has the format shown in the center of FIG. 5B, for example.

The topic posting part 264 posts the message(s) of the event “i” having the general-purpose format input from the message conversion part 262 as a topic(s) to the message queue 240 shown in FIG. 3A. When the message queue 240 succeeds in queuing the message(s) of the event “i” posted from the topic posting part 264, the message queue 240 returns a response to the terminal device IF part 26 indicating that queuing is successful. When the terminal device IF part 26 receives this response from the message queue 240, the terminal device IF part 26 stops processing until the terminal device IF part 26 receives the next event message from either mobile terminal device A 300 or mobile terminal device B 302.

The message queue 240 queues the message(s) of the event “i” posted from the topic posting part 264, and further outputs the queued message(s) of the event “i” to the message generation part 28. As shown in FIGS. 3A and 3C, in the message generation part 28, the message reception part 280 receives the message(s) of the event “i” output from the message queue 240. When the message reception part 280 further succeeds in receiving the message(s) of the event “i”, the message reception part 280 returns a response indicating success of receiving to the message queue 240. When the message queue 240 receives this response from the message reception part 280, the message queue 240 deletes the message of event “i” output to the message reception part 280 from the message queue 240.

The message reception part 280 outputs the message(s) of the event “i” input from the message queue 240 to the workflow selection part 282. When there is a workflow “i” for the event “i” corresponding to the message(s) of the event “i” from the event workflow DB 242 shown in FIG. 3A and FIG. 3D, the workflow selection part 282 outputs the message(s) of the event “i” to the message abstraction part 284, notifies the workflow processing part 286 of the workflow “i”, and starts the workflow “i”. The message abstraction part 284 abstracts the message(s) of the event “i” input from the workflow selection part 282. The message abstraction part 284 outputs the abstracted message(s) to the workflow processing part 286. The workflow processing part 286 processes the abstracted message(s) input from the message abstraction part 284 to generate a message(s) executable by the order processing apparatus 202. The workflow processing part 286 outputs the generated message(s) to the message queue 246 as a topic 248.

The abstracted message(s) of the payment event input from the message transmission/reception part 260 is abstracted by the message abstraction part 284 as described above to have the format shown on the right side of FIGS. 4A and 4B, for example. Also, the abstracted message(s) of the refund event input from the message transmission/reception part 260 is abstracted by the message abstraction part 284 as described above to have the format shown on the right side of FIGS. 5A and 5B, for example.

The message queue 246 queues the input topic 248. The order processing apparatus IF part 250 reads out the topic 248 including the generated message(s) from the message queue 246. The order processing apparatus IF part 250 outputs the message(s) included in the read out topic(s) 248 generated by the workflow processing part 286 to the order processing apparatus 202 via the mobile order IF device 200, and has the order processing apparatus 202 execute the event “i”.

For both of the mobile terminal device A 300 and the mobile terminal device B 302, in case of a common event such as a payment event, the abstracted message(s), workflow “i”, and generated message(s) are common. Furthermore, except in cases where the order processing apparatus 202 needs to support functions specific to the mobile terminal device, the generated message(s) is already Web API and HTTP/HTTPS protocol message(s) executable by the order processing apparatus 202 of the self-ordering system 22, so it is possible to support mobile terminal devices without modifying the program(s) of the order processing apparatus 202 and the POS device 206 of the self-ordering system 22.

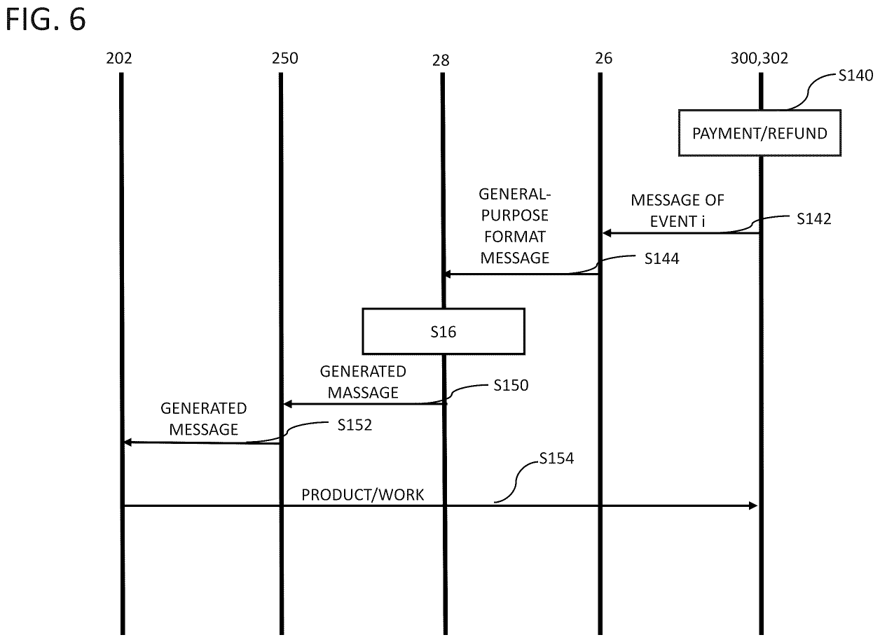

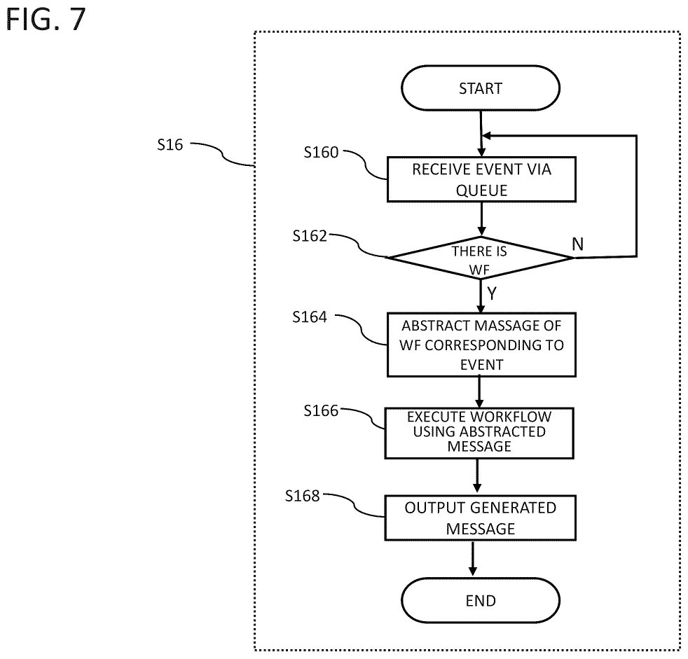

An exemplary operation of the self-ordering system 22 will be described below. FIG. 6 is a sequence diagram exemplifying an example operation of the self-ordering system 22 shown in FIG. 2, etc. FIG. 7 is a flow chart exemplifying an example process of S16 shown in FIG. 6. As shown in FIG. 6, two customers at the restaurant perform operations for the mobile terminal device A 300 and the mobile terminal device B 302 to cause the self-ordering system 22 to execute an event “i” of payment and refund (S140). The mobile terminal device A 300 and the mobile terminal device B 302 each output a message of the event “i” of payment and refund to the terminal device IF part 26 shown in FIG. 3A (S142).

The terminal device IF part 26 receives message(s) of the event “i” from each of the mobile terminal device A 300 and the mobile terminal device B 302 (refer toe the left side of FIGS. 4A to 5B). The terminal device IF part 26 converts the received message(s) of the event “i” into the general-purpose format (see the center of FIGS. 4A to 5B) to output the converted message(s) to the message generation part 28 via the message queue 240 (not shown in FIG. 6) shown in FIG. 3A (S144).

The message generation part 28 performs the process of S16 shown in FIG. 7 on the input message in the general-purpose format. The message generation part 28 outputs the message generated by the message generation part 28 through this process as a topic 248 to the order processing apparatus IF part 250 via the message queue 246 (S150). The order processing apparatus IF part 250 outputs the message generated by the message generation part 28 to the order processing apparatus 202 (S152).

The order processing apparatus 202 performs processing for the event “i” using the message of the event “i” input from the order processing apparatus IF part 250 to execute the event “i”. As a result, the services related to the event “i”, such as the payment and the refund, are provided to the users of the mobile terminal device A 300 and the mobile terminal device B 302 (S154).

An exemplary process of S16 will be described below with reference to FIG. 7. The message reception part 280 of the message generation part 28 receives an input of a message for an event “i” in the general-purpose format via the message queue 240. The message reception part 280 outputs the received message to the workflow selection part 282 (S160).

The workflow selection part 282 determines whether or not a workflow (WF) “i” for the event “i” corresponding to the message input from the message reception part 280 is stored in the event workflow DB 242. When the workflow “i” is stored in the event workflow DB 242 (Y in the process of S162), the workflow selection part 282 reads out the message, outputs the message to the message abstraction part 284, notifies the workflow processing part 286 of the workflow “i”, and starts the workflow. When the workflow “i” is not stored (N in the process of S162), the workflow selection part 282 returns to the process of S160 (S162).

The message abstraction part 284 receives the message of the event “i” from the workflow selection part 282. Further, the message abstraction part 284 abstracts the received message and outputs the abstracted message to the workflow processing part 286 (S164). The workflow processing part 286 executes the workflow using the abstracted message (S166). The generated message is output to the message queue 246 (S168).

Advantageous technical effects achieved by the self-ordering system 22 shown in FIG. 2 etc. will be described below. In the self-ordering system 22, a greater variety of mobile terminal devices can be connected to the message processing apparatus 24 compared to the case where mobile terminal devices are connected to the POS device 206. Therefore, the self-ordering system 22 can provide users with a wider variety of payment methods and the like than the self-ordering system 20, depending on the type of mobile terminal device connected.

It is also assumed that operations for the same event are performed on the self-ordering system 22 from the mobile terminal device A 300, the mobile terminal device B 302, and other mobile terminal devices. In such a case, it is possible to standardize the workflow and the event message(s) to be sent to the order processing apparatus 202 between these mobile terminal devices. Further, in addition to these mobile terminal devices, new mobile terminal devices can be connected to the self-ordering system 22 simply by adding only functions specific to the new mobile terminal device to the processing of the message processing apparatus 24.

Further, in the self-ordering system 22, event message(s) is transmitted and received between the components of the message processing apparatus 24 via message queues 240 and 246. Therefore, even when new mobile terminal devices are introduced into the self-ordering system 22, there is no need to stop the operation of the self-ordering system 22. In other words, an administrator of the self-ordering system 22 can connect new mobile terminal devices to the message processing apparatus 24 at any time, without having to synchronize the processing timing of each component of the self-ordering system 22.

Also, the administrator of the self-ordering system 22 can similarly modify the program(s) that connects a new mobile terminal device to the message processing apparatus 24 at any time. Further, the self-ordering system 22 makes it possible to provide a wide variety of services to customers also in addition to payment and refund. Further, even when format(s) of message(s) transmitted and received between the mobile terminal devices and the message processing apparatus 24 differ for each of companies providing services, the message processing apparatus 24 can absorb the differences in messages. Therefore, the message processing apparatus 24 allows the service provided by each of the companies to be provided to customers efficiently.

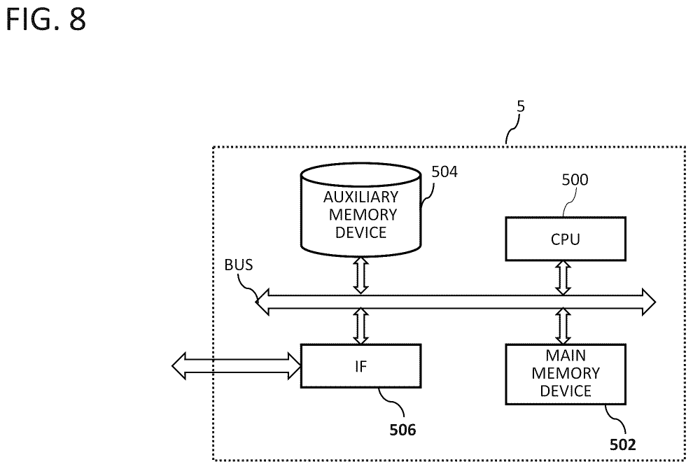

An example configuration of the information processing apparatus 5 that executes a program(s) realizing the processing of the components of the self-ordering systems 20 and 22 will be described below. FIG. 8 is a diagram exemplifying an example configuration of the information processing apparatus 5 executing a program(s) realizing the processing of the components of the self-ordering systems 20 and 22. Each function of the self-ordering systems 20 and 22 can be realized by a program(s) executed by the information processing apparatus (computer) 5 having a configuration shown in FIG. 8.

As shown in FIG. 8, the information processing apparatus 5 includes a CPU (Central Processing Part) 500, a main memory device 502, an auxiliary memory device 504, and an interface (IF) part 506 that are interconnected via a bus to input and output information. However, the information processing apparatus 5 may include hardware components other than those shown in FIG. 8, and the components of the information processing apparatus 5 may be distributed across multiple apparatus. In other words, the configuration of the information processing apparatus 5 is not limited to the configuration shown in FIG. 8.

The CPU 500 executes instructions included in a program(s) executed by the information processing apparatus 5 and required for the processing of the self-ordering systems 20 and 22. The main memory device 502 includes memory devices such as a RAM (Random Access Memory) and a ROM (Read Only Memory), and temporarily stores data used by the CPU 500 to execute the program(s).

The auxiliary memory device 504 includes, for example, a non-volatile storage device such as a hard disk drive (HDD), a solid state drive (SSD), and a flash memory, and stores the program(s) executed by the CPU 500 for a medium to long term. The program(s) stored in the auxiliary memory device 504 can be provided and distributed as products stored in non-transitory computer-readable storage media such as magnetic storage media, CDs, and DVDs.

The IF part 506 provides an interface for inputting and outputting information between the mobile order service 10 and the self-ordering systems 20 and 22. The IF part 506 also provides an interface for inputting and outputting information between the POS device 206 and the message processing apparatus 24 and the mobile terminal device A 300 and the mobile terminal device B 302.

As described above, each of the components of the self-ordering systems 20 and 22 can be realized by a program(s) executed by the information processing apparatus 5. On the other hand, these components may be realized by dedicated hardware, or by an appropriate combination of hardware and software (program(s)) executed by the information processing apparatus 5. Further, as described above, since the components of the self-ordering systems 20 and 22 can be realized by a program(s), the content of the processing executed in the components of the self-ordering systems 20 and 22 can be understood as a processing method.

The present application may include the following modes, but is not limited to these.

### Mode 1

A message processing apparatus, comprising:
a terminal device interface part configured to be connected to a plurality of terminal devices with a first API provided by each of the plurality of terminal devices;
an order processing apparatus interface part configured to be connected to a self-ordering system with a second API different from the first API via a mobile order interface;
an event workflow database configured to have correspond each of a plurality of events and each of a plurality of workflows to each other to store the events and the workflows; and
a message generation part configured to receive an event message(s) of the first API and generate a message(s) corresponding to the second API.

### Mode 2

The message processing apparatus according to mode 1, wherein the message generation part converts the first API provided by each of the plurality of terminal devices into an abstracted message(s) and processes the abstracted message(s) in a workflow corresponding to the event to generate a message(s) corresponding to the second API.

### Mode 3

The message processing apparatus according to mode 1 or 2, comprising: a first message queue configured to queue message(s) for each of the plurality of events converted from the first API into a general-purpose format between the order processing apparatus interface part and the message generation part; and a second message queue configured to queue message(s) converted into a second API format between the message generation part and the order processing apparatus interface part.

### Mode 4

The message processing apparatus according to any one of modes 1 to 3, wherein the events include one or more of making a reservation at a restaurant, ordering food(s)/drink(s), paying for the ordered food(s)/drink(s), refunding payment for the food(s)/drink(s), notifying the detail of a food order to a chef(s) in a kitchen, and managing the time required from ordering the food(s)/drink(s) to serving the food(s)/drink(s).

### Mode 5

The message processing apparatus according to any one of modes 1 to 4, wherein each of the plurality of terminal devices is configured to transmit to the reception part a message(s) in a format compatible with each of the services provided by a plurality of companies.

### Mode 6

The message processing apparatus according to any one of modes 1 to 5, wherein a service(s) provides at least one of a product and a work.

### Mode 7

A self-ordering system comprising a message processing apparatus described in any one of modes 1 to 5, and an order processing apparatus is provided. The order processing apparatus is configured to receive a message(s) of the event corresponding to the generated second API and to perform a process of the event.

### Mode 8

A message processing method comprising: comprising: a reception step, a message conversion step, a workflow selection step, a message abstraction step, a message generation step, and a message generation step.

The reception step receives a message(s) of each of a plurality of events from each of a plurality of terminal devices with a first API that differs for each of the plurality of terminal devices.

The message conversion step converts the received message(s) for each of the plurality of events into a general-purpose format independent of the plurality of terminal devices.

The workflow selection step selects from the event workflow database one of the plurality of workflows corresponding to the message(s) of one of the plurality of events converted into the general-purpose format. The message abstraction step abstracts the message(s) of the event corresponding to the selected workflow by converting the message(s) into a format that includes all of the messages of the plurality of events.

The message generation step executes the selected workflow with the abstracted message(s) of the event to generate a message(s) corresponding to a second API.

The message output step of outputting the generated message(s) corresponding to the second API.

### Mode 9

A program, comprising a storage process, a reception process, a message conversion process, a workflow selection process, a message abstraction process, a message generation process and a message output process.

The storage process has correspond each of a plurality of events and each of a plurality of workflows to each other to store the events, the workflows in an event workflow database.

The reception process receives a message(s) of each of a plurality of events from each of a plurality of terminal devices with a first API that differs for each of the plurality of terminal devices.

The message conversion process converts the received message(s) for each of the plurality of events into a general-purpose format independent of the plurality of terminal devices.

The workflow selection process selects from the event workflow database one of the plurality of workflows corresponding to the message(s) of one of the plurality of events converted into the general-purpose format.

The message abstraction process abstracts the message(s) of the event corresponding to the selected workflow by converting the message(s) into a format that includes all of the messages of the plurality of events. The message generation process executes the selected workflow with the abstracted message(s) of the event to generate a message(s) corresponding to a second API.

The message output process outputs the generated message(s) corresponding to the second API.

The disclosures of the cited patent documents, etc. are incorporated herein by reference. Within the scope of all disclosures (including the scope of claims), modifications and adjustments of the embodiments and examples are possible based on the basic technical ideas. In addition, various combinations or selections (including partial deletions) of various disclosed elements (including each element of each claim, each element of an example embodiment or example, each element of each drawing, etc.) are possible within the framework of all disclosures. That is, the present disclosure includes all the disclosures including the claims, and various modifications and alterations that a person skilled in the art would be able to make according to the technical ideas. That is, it is taken for accounted that the present disclosure includes all the disclosures including the claims, and various modifications and alterations that a person skilled in the art would be able to achieve according to the technical ideas. In particular, with respect to the numerical ranges described in this specification, any numerical value or subrange included within the range should be interpreted as being specifically described unless otherwise noted. Furthermore, the disclosures of the above patent documents, if necessary, in accordance with the spirit of this disclosure, and when used in part or in whole in combination with the descriptions in this specification as part of this disclosure, are also deemed to be included in the disclosures of this application.

### REFERENCE SIGNS LIST

10 Mobile Order Service
20, 22 Self-Ordering System
200 Mobile Order Interface Device
202 Order Processing Apparatus
204 Kitchen Printer Device
206 POS Device
208 Handheld Terminal Device
210 Self-Order Terminal Device
300 Mobile Terminal Device A
302 Mobile Terminal Device B
24 Message Processing Apparatus
240 Message Queue
242 Event Workflow DB
246 Message Queue
248 Topic
250 Order Processing Apparatus Interface Part
26 Terminal Device IF Part
260 Message Transmission/Reception Part
262 Message Conversion Part
264 Topic Posting Part
28 Message Generation Part
280 Message Reception Part
282 Workflow Selection Part
284 Message Abstraction Part
286 Workflow Processing Part
5 Information Processing Apparatus
500 CPU
502 Main Memory Device
504 Auxiliary Memory Device
506 Interface Part (IF)

What is claimed is:

1. A message processing apparatus, comprising:
a terminal device interface part configured to be connected to a plurality of terminal devices with a first API provided by each of the plurality of terminal devices;
an order processing apparatus interface part configured to be connected to a self-ordering system with a second API different from the first API via a mobile order interface;
an event workflow database configured to have each of a plurality of events and each of a plurality of workflows correspond to each other to store the events and the workflows; and
a message generation part configured to receive an event message(s) of the first API and generate a message(s) corresponding to the second API.

2. The message processing apparatus according to claim 1, wherein the message generation part converts the first API provided by each of the plurality of terminal devices into an abstracted message(s) and processes the abstracted message(s) in a workflow corresponding to the event to generate the message(s) corresponding to the second API.

3. The message processing apparatus according to claim 1, comprising:
a first message queue configured to queue message(s) for each of the plurality of events converted from the first API into a general-purpose format between the order processing apparatus interface part and the message generation part; and
a second message queue configured to queue message(s) converted into a second API format between the message generation part and the order processing apparatus interface part.

4. The message processing apparatus according to claim 1, wherein the events include one or more of making a reservation at a restaurant, ordering food(s)/drink(s), paying for the ordered food(s)/drink(s), refunding payment for the food(s)/drink(s), notifying the detail of a food order to a chef(s) in a kitchen, and managing the time required from ordering the food(s)/drink(s) to serving the food(s)/drink(s).

5. The message processing apparatus according to claim 1, wherein each of the plurality of terminal devices is configured to transmit to the terminal device interface part a message(s) in a format compatible with each of the services provided by a plurality of companies.

6. The message processing apparatus according to claim 5, wherein a service(s) provides at least one of a product and a work.

7. A self-ordering system, comprising:
a message processing apparatus according to claim 1; and
an order processing apparatus configured to receive a message(s) of the event corresponding to the generated second API and to perform a process of the event.

8. A message processing method, comprising:
having each of a plurality of events and each of a plurality of workflows correspond to each other to store the events and the workflows in an event workflow database;
receiving a message(s) of each of a plurality of events from each of a plurality of terminal devices with a first API that differs for each of the plurality of terminal devices;
converting the received message(s) for each of the plurality of events into a general-purpose format independent of the plurality of terminal devices;
selecting from the event workflow database one of the plurality of workflows corresponding to the message(s) of one of the plurality of events converted into the general-purpose format;
abstracting the message(s) of the event corresponding to the selected workflow by converting the message(s) into a format that includes all of the messages of the plurality of events;
executing the selected workflow with the abstracted message(s) of the event to generate a message(s) corresponding to a second API; and
outputting the generated message(s) corresponding to the second API.

9. A non-transitory computer readable storage medium storing a program, wherein the program causes a processor processes of:
having each of a plurality of events and each of a plurality of workflows correspond to each other to store the events and the workflows in an event workflow database;
receiving a message(s) of each of a plurality of events from each of a plurality of terminal devices with a first API that differs for each of the plurality of terminal devices;
converting the received message(s) for each of the plurality of events into a general-purpose format independent of the plurality of terminal devices;
selecting from the event workflow database one of the plurality of workflows corresponding to the message(s) of one of the plurality of events converted into the general-purpose format;
abstracting the message(s) of the event corresponding to the selected workflow by converting the message(s) into a format that includes all of the messages of the plurality of events;
executing the selected workflow with the abstracted message(s) of the event to generate a message(s) corresponding to a second API; and
outputting the generated message(s) corresponding to the second API.
